(19) United States
(12) Patent Application Publication
(10) Pub. No.: US 2025/0363770 A1
(43) Pub. Date: Nov. 27, 2025

(54) IMAGE DETERMINATION METHOD AND SYSTEM

(71) Applicant: POSICUBE CO.,LTD., Seoul (KR)

(72) Inventor: Keon Ho KIM, Hwaseong-si (KR)

(73) Assignee: POSICUBE CO.,LTD., Seoul (KR)

(21) Appl. No.: 19/293,074

(22) Filed: Aug. 7, 2025

Related U.S. Application Data
(63) Continuation of application No. PCT/KR2023/011502, filed on Aug. 4, 2023.

(30) Foreign Application Priority Data
Feb. 8, 2023 (KR) 10-2023-0016532

(51) Int. Cl. G06V 10/42; G06T 7/11; G06V 10/44

(52) U.S. Cl. CPC G06V 10/431; G06T 7/11; G06V 10/44; G06T 2207/20084

(57) ABSTRACT

There is provided an image determination method and system. The image determination method includes: converting a target image in a spatial domain into an image in a frequency domain; extracting first image data associated with a first frequency band by applying a first band mask to the frequency-domain image; extracting second image data associated with a second frequency band by applying a second band mask to the frequency-domain image, wherein the first and second frequency bands have an overlapping band region; generating a plurality of images by inverse-transforming the first image data and the second image data into the spatial domain; and determining authenticity of the target image based on features extracted from the plurality of images. According to the image determination method and system, the authenticity of the target image can be accurately determined.

### CROSS-REFERENCE TO RELATED APPLICATIONS

The present application is a continuation of International Patent Application No. PCT/KR2023/011502 filed on Aug. 4, 2023, which is based upon and claims the benefit of priority to Korean Patent Application No. 10-2023-0016532 filed on Feb. 8, 2023. The disclosures of the above-listed applications are hereby incorporated by reference herein in their entirety.

### TECHNICAL FIELD

The present disclosure relates to an image determination method and a system thereof, and more particularly, to a method for determining authenticity of an image using a deep learning technique and a system for performing the method.

### BACKGROUND ART

With the spread of Internet-only banks and mobile banking, many users are utilizing various financial services in a non-face-to-face manner. For example, many users conveniently use financial services such as opening new accounts through non-face-to-face authentication using captured images of ID cards.

However, as the use of non-face-to-face financial services increases, financial crimes exploiting the vulnerability of non-face-to-face authentication are also on the rise. For example, due to criminals who have passed non-face-to-face authentication by stealing images of other people's ID cards, financial crimes such as non-face-to-face loan fraud and unauthorized deposit withdrawals are rapidly increasing. Criminals can easily steal ID card images by capturing a printout of someone else's ID card or an image displayed on a monitor.

Accordingly, a technology capable of compensating for the vulnerability of non-face-to-face authentication by accurately determining the authenticity of an ID card image is urgently required.

### DISCLOSURE

### Technical Problems

A technical problem to be solved by some embodiments of the present disclosure is to provide a method for accurately determining the authenticity of an image (e.g., an ID card image) and a system for performing the method.

The technical problems of the present disclosure are not limited to those mentioned above, and other technical problems not mentioned will be clearly understood by those skilled in the art from the following description.

### Technical Solutions

According to an aspect of the present disclosure, an image determination method performed by at least one computing device, comprise: converting a target image in a spatial domain into an image in a frequency domain, extracting first image data associated with a first frequency band by applying a first band mask to the frequency-domain image, extracting second image data associated with a second frequency band by applying a second band mask to the frequency-domain image, wherein the first and second frequency bands have an overlapping band region, generating a plurality of images by inverse-transforming the first image data and the second image data into the spatial domain, and determining authenticity of the target image based on features extracted from the plurality of images.

In one embodiment, the target image may be an image related to a subject on which personal information is recorded.

In one embodiment, the subject may include at least one of an ID card and a card.

In one embodiment, the target image may be obtained during a process of authenticating a user who has requested a financial service, and an authentication result for the user may be determined based on a result of the determining of the authenticity of the target image.

In one embodiment, the plurality of images may include an image associated with the first frequency band and an image associated with the second frequency band.

In one embodiment, the first band mask may be configured to extract data of a region formed in a diagonal direction in the frequency-domain image.

In one embodiment, the extracting of the first image data may comprise: extracting image data located in a region of the first frequency band in the frequency-domain image through the first band mask; and generating the first image data by reflecting values of learnable parameters on the extracted image data, and the values of the learnable parameters may be updated based on differences between authenticity prediction values and correct labels for training image samples.

In one embodiment, the band region may be a first band region, the generating of the plurality of images may comprise: extracting third image data associated with a third frequency band by applying a third band mask to the frequency-domain image; and generating the plurality of images by further inverse-transforming the third image data, the third frequency band may have a second band region that overlaps the second frequency band or another frequency band, and a width of the first band region may be equal to a width of the second band region.

In one embodiment, the plurality of images may be first images, the extracted features may be first features, and the determining of the authenticity of the target image may comprise: generating a plurality of image patches from the target image; converting the plurality of image patches into the frequency domain, extracting multiple image data of different frequency bands through a plurality of band masks, generating second images by inverse-transforming the multiple image data of the different frequency bands into the spatial domain, and determining the authenticity of the target image based further on second features extracted from the second images.

In one embodiment, the determining of the authenticity of the target image may comprise: extracting the features through a convolutional neural network (CNN)-based feature extractor, and determining the authenticity of the target image through a fully-connected-layer-based predictor.

In one embodiment, the determining of the authenticity of the target image may comprise determining whether the target image is a first-shot image obtained by capturing a physical subject or a second-shot image obtained by re-capturing the first-shot image.

In one embodiment, the determining of the authenticity of the target image may comprise determining whether the target image is an image obtained by capturing a three-dimensional subject or an image obtained by capturing a two-dimensional subject.

According to an aspect of the present disclosure, an image determination method performed by at least one computing device, comprises: generating a plurality of image patches from a target image in a spatial domain, converting the plurality of image patches into image patches in a frequency domain, extracting first image data associated with a first frequency band by applying a first band mask to the frequency-domain image patches, extracting second image data associated with a second frequency band by applying a second band mask to the frequency-domain image patches, wherein the first frequency band and the second frequency band have an overlapping band region, generating a plurality of images by inverse-transforming the first image data and the second image data into the spatial domain, and determining the authenticity of the target image based on features extracted from the plurality of image.

In one embodiment, the target image may be obtained by decoding an image compressed through a block-based image compression scheme, and a size of each of the image patches may be set to a block size of the image compression scheme or a multiple of the block size.

In one embodiment, the extracting of the first image data may comprise: extracting a plurality of patch data associated with the first frequency band from the frequency-domain image patches through the first band mask, and generating the first image data by aggregating the plurality of patch data.

According to an aspect of the present disclosure, an image determination system comprises: at least one processor, and a memory storing instructions, wherein the at least one processor is configured to perform, by executing the stored instructions, operations of: converting a target image in a spatial domain into an image in a frequency domain, extracting first image data associated with a first frequency band by applying a first band mask to the frequency-domain image, extracting second image data associated with a second frequency band by applying a second band mask to the frequency-domain image, wherein the first and second frequency bands have an overlapping band region, generating a plurality of images by inverse-transforming the first image data and the second image data into the spatial domain, and determining authenticity of the target image based on features extracted from the plurality of images.

In one embodiment, the target image may be an image related to a subject on which personal information is recorded.

In one embodiment, the subject may include at least one of an ID card and a card.

In one embodiment, the target image may be obtained during a process of authenticating a user who has requested a financial service, and an authentication result for the user may be determined based on a result of the determining of the authenticity of the target image.

In one embodiment, the plurality of images may include an image associated with the first frequency band and an image associated with the second frequency band.

### Advantageous Effects

According to exemplary embodiments of the present disclosure, image data can be separated and extracted by frequency bands through a plurality of band masks, and the authenticity of an image can be determined by comprehensively considering features extracted from the image data. Accordingly, the accuracy of authenticity determination for the image can be significantly improved.

In addition, by configuring the plurality of band masks to have overlapping band regions, image data associated with different frequency bands can be extracted without information loss. As a result, the accuracy of authenticity determination for the image can be further improved.

Furthermore, by performing frequency domain transformation and inverse transformation in units of image patches, features for local regions of the image can be extracted. Then, a block-level loss pattern appearing in a compressed image such as JPEG can be detected more accurately, thereby further improving the accuracy of authenticity determination for the image.

Moreover, by performing frequency domain transformation and inverse transformation on a per-image basis, a first feature for the entire image (i.e., a global region) can be extracted, and by performing frequency domain transformation and inverse transformation on a per-image patch basis, a second feature for a local region of the image can be extracted. Then, the authenticity of the image can be determined based on both the first and second features. Accordingly, the accuracy of authenticity determination for the image can be further improved. For example, in the case of a second-shot image (e.g., a JPEG image), due to block-level data loss (i.e., two instances of data loss), the difference between the two features becomes greater, and thus, the accuracy of authenticity determination for the image can be further enhanced by considering both features together.

Also, by determining the authenticity of an ID card image, the vulnerability of the non-face-to-face authentication function can be compensated for, and the security of non-face-to-face financial services can be greatly enhanced.

The advantageous effects according to the technical idea of the present disclosure are not limited to the above-mentioned effects, and other effects not mentioned will be clearly understood by those skilled in the art from the following description.

### BRIEF DESCRIPTION OF DRAWINGS

FIG. 1 is an exemplary diagram for schematically explaining the operation of an image determination system according to some embodiments of the present disclosure.

FIG. 2 is an exemplary flowchart schematically illustrating an image determination method according to some embodiments of the present disclosure.

FIG. 3 illustrates an image preprocessing process according to some embodiments of the present disclosure.

FIG. 4 is an exemplary flowchart illustrating a detailed process of an authenticity determination step for a target image depicted in FIG. 2.

FIG. 5 is an exemplary diagram for further explaining the detailed process of the authenticity determination step for a target image depicted in FIG. 2.

FIG. 6 illustrates a frequency distribution of a frequency-domain image that may be referenced in some embodiments of the present disclosure.

FIG. 7 is an exemplary diagram for explaining a band mask design method according to some embodiments of the present disclosure.

FIG. 8 is an exemplary diagram for explaining a band mask design method according to other embodiments of the present disclosure.

FIG. 9 is an exemplary diagram for explaining a band mask design method according to still other embodiments of the present disclosure.

FIG. 10 is an exemplary diagram for explaining a band mask design method according to yet other embodiments of the present disclosure.

FIG. 11 illustrates a process of extracting image data for different frequency bands through a plurality of band masks according to some embodiments of the present disclosure.

FIG. 12 is an exemplary flowchart for explaining an image determination method according to other embodiments of the present disclosure.

FIG. 13 is an exemplary diagram for further explaining the image determination method according to other embodiments of the present disclosure.

FIG. 14 illustrates a process of extracting image data for different frequency bands through a plurality of band masks according to other embodiments of the present disclosure.

FIG. 15 is an exemplary diagram for explaining an image determination method according to still other embodiments of the present disclosure.

FIG. 16 is an exemplary configuration diagram for explaining an application example of the image determination system according to some embodiments of the present disclosure.

FIG. 17 illustrates an exemplary computing device that can implement the image determination system according to some embodiments of the present disclosure.

### BEST MODES FOR CARRYING OUT THE INVENTION

Preferred embodiments of the present disclosure will hereinafter be described in detail with reference to the accompanying drawings. The advantages and features of the present disclosure, and the methods for achieving them, will become apparent with reference to the embodiments described below in detail together with the accompanying drawings. However, the technical scope of the present disclosure is not limited to the following embodiments but can be implemented in various forms. The following embodiments are provided merely to fully describe the technical scope of the present disclosure and to fully inform those skilled in the art to which the present disclosure pertains of its scope. The technical scope of the present disclosure is defined only by the claims.

When adding reference numerals to components in each drawing, it should be noted that, where possible, the same numerals are used for the same components, even if they are depicted in different drawings. Furthermore, in describing the present disclosure, detailed explanations of related known configurations or functions may be omitted if it is determined that such details could obscure the gist of the present disclosure.

Unless otherwise defined, all terms (including technical and scientific terms) used herein can be interpreted as having meanings commonly understood by those skilled in the art to which the present disclosure pertains. Terms generally defined in dictionaries are not ideally or excessively interpreted unless explicitly defined otherwise. The terms used herein are intended to describe the embodiments and are not intended to limit the present disclosure. Singular terms used herein include plural forms unless specifically stated otherwise.

Additionally, in describing the components of the present disclosure, terms such as first, second, A, B, (a), (b), and the like may be used. These terms are used merely to distinguish one component from another and do not limit the nature, sequence, or order of the components. When a component is described as being “connected,” “coupled,” or “linked” to another component, it should be understood that the component may be directly connected or linked to the other component, or another component may be “connected,” “coupled,” or “linked” between them.

The terms “comprises” and/or “comprising” as used in this specification do not exclude the presence or addition of one or more other components, steps, actions, and/or elements in addition to the stated components, steps, actions, and/or elements.

Some embodiments of the present disclosure will hereinafter be described in detail with reference to the accompanying drawings.

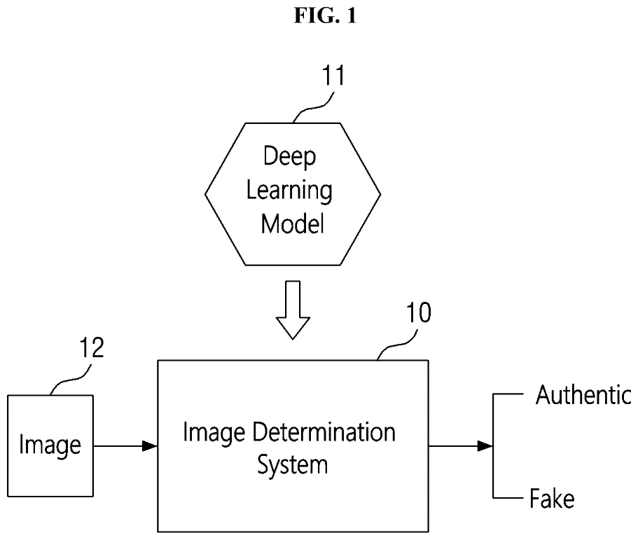

FIG. 1 is an exemplary diagram for schematically explaining the operation of an image determination system 10 according to some embodiments of the present disclosure.

As illustrated in FIG. 1, the image determination system 10 may be a device/system capable of determining the authenticity of a given image 12 using a deep learning model 11. For example, the image determination system 10 may train the deep learning model 11 using training image samples (i.e., a labeled dataset) given with correct labels, and may determine the authenticity of the image 12 through the trained deep learning model 11. For convenience of explanation, the image determination system 10 will hereinafter be referred to as the determination system 10.

The image 12 may include, without limitation, various images that require authenticity determination. For example, the image 12 may be a captured image of a subject on which personal information is recorded, and the subject may be, for example, an ID card (e.g., a resident registration card, passport, driver's license, and the like), a bankbook, or a card. However, the scope of the present disclosure is not limited thereto. For ease of understanding, however, the following description will be continued under the assumption that the image 12 is an ID-related image.

In addition, a genuine image may refer to, for example, a first-shot image captured directly from a real-world subject (e.g., a three-dimensional subject), such as an image of an ID card, but the scope of the present disclosure is not limited thereto.

Meanwhile, a fake image refers to an image that is not a genuine image, and may include, for example, a second-shot image generated by re-capturing the first-shot image, or a captured image of a two-dimensional subject (e.g., a monitor screen, printed paper, and the like), but the scope of the present disclosure is not limited thereto. Specifically, if the subject is an ID card, then a captured image of a printed ID card, a captured image of an ID card displayed on a monitor screen, and a re-captured image of an ID card may all be regarded as fake images.

For reference, a fake image may also be referred to as a “manipulated image,” “fake image,” “altered image,” or “forged image,” depending on the case.

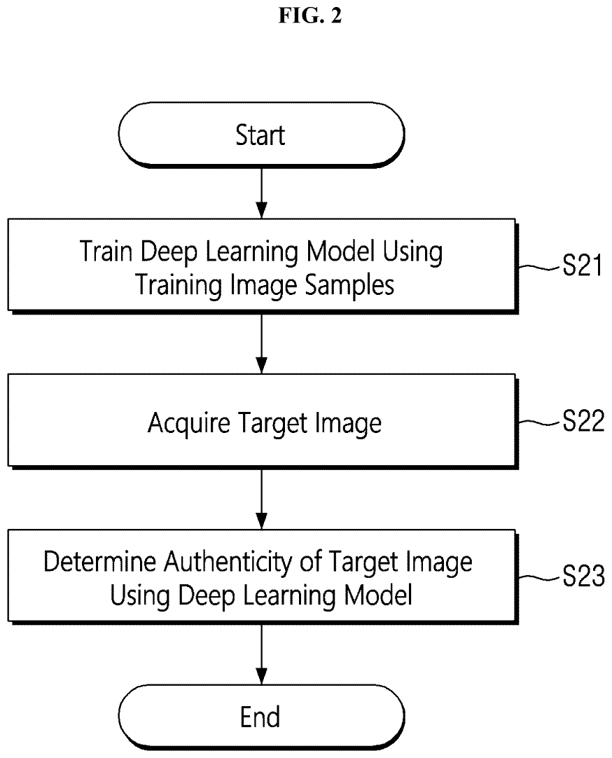

A detailed method by which the determination system 10 determines the authenticity of the image 12 based on the deep learning model 11 will be described in detail later with reference to FIG. 2 and the drawings that follow.

The above-described determination system 10 may be implemented by at least one computing device. For example, all functions of the determination system 10 may be implemented on a single computing device, or a first function of the determination system 10 may be implemented on a first computing device and a second function on a second computing device. Alternatively, a specific function of the determination system 10 may be implemented across a plurality of computing devices.

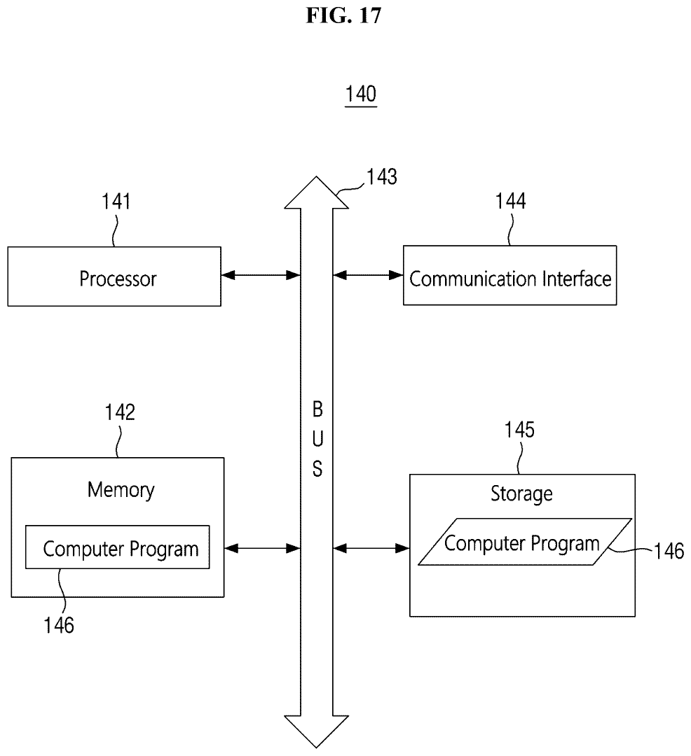

The computing device may include any device having a computing function, and an example of such a device will be described later with reference to FIG. 17. Since a computing device is an aggregate of various components (e.g., memory, processor, and the like) that interact with each other, it may be referred to as a “computing system.” The term “computing system” may also refer to an aggregate in which multiple computing devices interact with one another.

Up to this point, the operation of the determination system 10 according to some embodiments of the present disclosure has been schematically described with reference to FIG. 1. Hereinafter, with reference to FIG. 2 and the subsequent drawings, various methods (i.e., detailed operations) that can be performed in the determination system 10 will be described in detail. In the following description, for clarity of the disclosure, unless directly referring to a figure, reference numerals for components such as the deep learning model 11 in FIG. 1 will be omitted, and even for identical or similar components, different reference numerals may be used depending on the embodiment.

In addition, for case of understanding, the following description assumes that all steps/operations of methods to be described are performed by the above-described determination system 10. Therefore, when the subject of a particular step/operation is omitted, it may be understood as being performed by the determination system 10. However, in actual environments, some steps/operations of the methods described below may be performed by other computing devices. For example, training of the deep learning model 11 in FIG. 1 may be performed by another computing device.

FIG. 2 is an exemplary flowchart schematically illustrating an image determination method according to some embodiments of the present disclosure. However, it is noted that this is merely a preferred embodiment for achieving the objectives of the present disclosure, and some steps may be added or omitted as necessary.

As illustrated in FIG. 2, the present embodiments may begin with step S21 of training a deep learning model using training image samples. For example, the determination system 10 may train a deep learning model using training image samples provided with correct labels (e.g., labels indicating genuine class or fake class) (e.g., updating weights of a feature extractor 56 and a predictor 57, which will be described later). At this time, the deep learning model may be configured to output prediction values for authenticity determination (e.g., confidence scores per class), and may be trained based on the differences (i.e., loss) between the prediction values and the correct labels. The differences may be calculated by a loss function such as cross-entropy, but the scope of the present disclosure is not limited thereto.

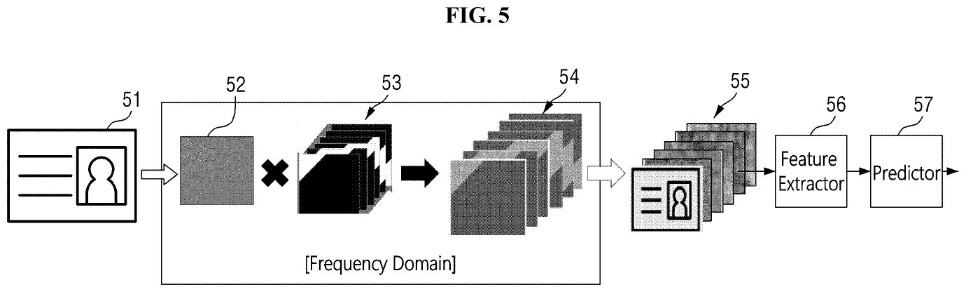

For reference, the predictor (e.g., 57 in FIG. 5) of the deep learning model may be configured to perform binary classification for authenticity or may be configured to perform multi-class classification (e.g., distinguishing between a genuine image, a monitor-captured image, and a printed-paper-captured image).

For the structure of the deep learning model, the description of FIG. 5 and the like will be referenced. For the preprocessing and/or feeding (feedforward) process of the training image samples, steps S22 and S23 will be referenced.

Meanwhile, in some embodiments, training image samples may be generated to include not only the subject region but also a portion of the background region of a subject. For example, in building a deep learning model for determining the authenticity of an image of an ID card, instead of extracting only the ID card region from the entire image (i.e., an image including both the ID card region and the background), training image samples may be generated by extracting a portion of the background together with the ID card region. In this case, the deep learning model may be trained to perform authenticity determination while taking into account the subject's capture environment, thereby further improving the accuracy of image determination.

In step S22, a target image may be acquired. Here, the target image may be an image preprocessed to match a predefined input format, or may be a raw image that has not been preprocessed. If the target image does not match the predefined input format, appropriate preprocessing may be performed on the target image.

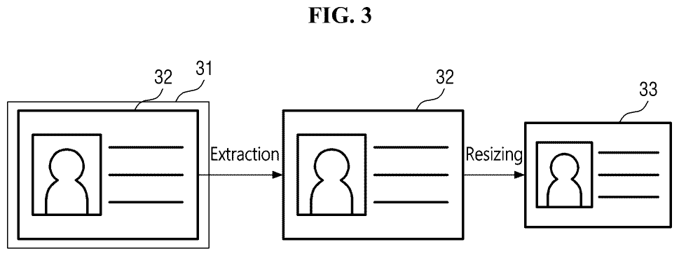

For example, as illustrated in FIG. 3, assuming that the target image 31 is a captured image of a subject 32, the determination system 10 may extract (crop) a region including the subject 32 from the target image 31, and resize an extracted image 33 to a predefined size (see 34). In this manner, the accuracy of authenticity determination for the target image 31 can be improved. In some cases, the determination system 10 may perform extraction such that a portion of the background region of the subject 32 is included.

As another example, if the target image is a compressed (encoded) image (e.g., a JPEG image), the determination system 10 may decode the target image and convert it into an RGB image.

As yet another example, the determination system 10 may perform preprocessing on the target image based on various combinations of the above examples. For example, the determination system 10 may decode the target image into an RGB image and then perform the preprocessing illustrated in FIG. 3 on the RGB image.

The description will now return to FIG. 2.

In step S23, the authenticity of the target image may be determined using the trained deep learning model. Here, the target image may refer to an image in a spatial domain (e.g., an RGB image), and in the relevant technical field, the spatial domain may also be referred to as a “pixel domain” or “image domain.”

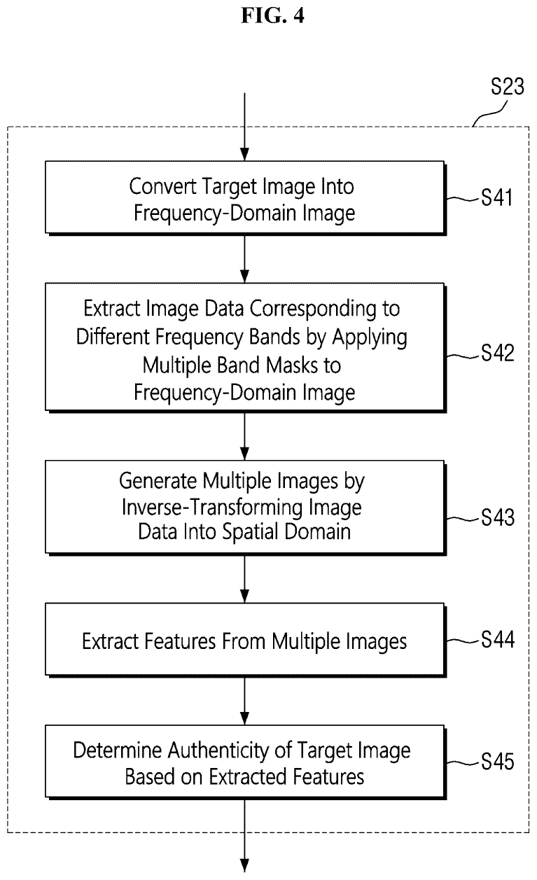

The detailed process of step S23 is depicted in FIG. 4. FIG. 4 illustrates the feeding process (or preprocessing and feeding process) for the target image, and the same process may also be performed for training image samples. The description will be continued with reference to FIG. 4.

In step S41, the target image may be transformed into an image in a frequency domain. For example, as illustrated in FIG. 5, the determination system 10 may transform a target image 51 into a frequency-domain image 52 through a transformation technique such as Discrete Cosine Transform (DCT) or Discrete Fourier Transform (DFT). One of ordinary skill in the art may already be familiar with how to convert a spatial-domain image into the frequency-domain image using a technique such as DCT or DFT, and thus a detailed explanation thereof will be omitted.

Meanwhile, although not explicitly illustrated in FIG. 5, the module that performs the above-described transformation may be referred to as a “transformer,” and such a transformer may or may not be considered a component of the deep learning model.

In step S42, image data associated with different frequency bands may be extracted by applying a plurality of band masks to the frequency-domain image. For example, as illustrated in FIG. 5, the determination system 10 may extract image data 54 associated with different frequency bands by using a plurality of band masks 53 configured to extract data for specific frequency bands from the frequency-domain image 52. For example, the determination system 10 may extract first image data associated with a first frequency band by applying a first band mask to the frequency-domain image 52 to, and extract second image data associated with a second frequency band by applying a second band mask to the frequency-domain image 52. FIG. 5 illustrates an example where the number of band masks is six.

Although not explicitly illustrated in FIG. 5, the module that performs the above-described data extraction may be referred to as an “extractor,” “filter,” or “separator,” and such an extractor/filter/separator may or may not be considered a component of the deep learning model.

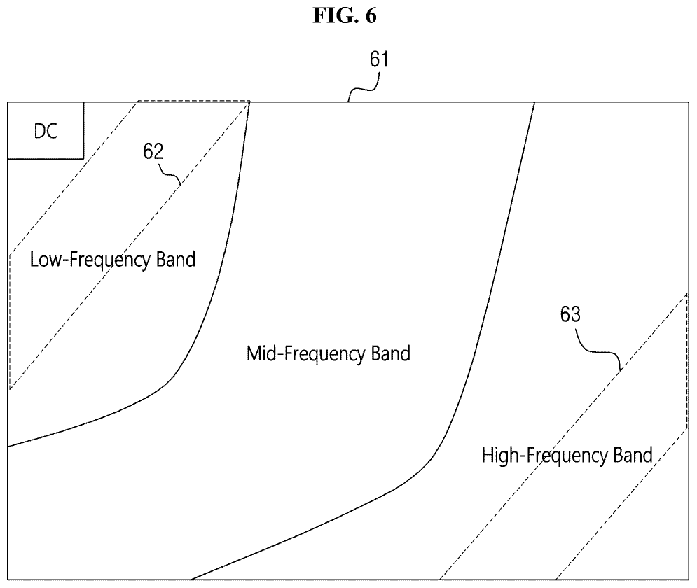

For case of understanding, further explanation of the band masks 53 and step S42 will be provided with reference to FIGS. 6 through 11.

FIG. 6 illustrates the frequency distribution of a frequency-domain image 61 that may be referenced in some embodiments of the present disclosure. FIG. 6 assumes that the frequency-domain image 61 is generated through a DCT technique.

As illustrated in FIG. 6, a low-frequency region is located at the upper left of the frequency-domain image 61, and higher frequency regions are located progressively toward the lower right. Accordingly, by extracting data from regions (see 62 and 63) formed along the lower-left to upper-right diagonal direction in the frequency-domain image 61, data of a desired frequency band may be extracted. For example, if data of a first region 62 is extracted, low-frequency band data may be extracted, and if data of a second region 63 is extracted, high-frequency band data may be extracted. A band mask may also be referred to as a “band pass filter” or a “band filter.”

Each band mask may be designed/configured to extract data of a desired frequency band using the above-described principle, but their specific implementation may vary.

For example, each band mask may be designed to have the same size as a frequency-domain image and include a blocking region and a pass region. Here, the blocking region refers to the region of a frequency band to be blocked (see the black areas in FIG. 5), and the pass region refers to the region of a frequency band to be passed (see the white areas in FIG. 5). When each band mask is applied to the frequency-domain image through an operation such as multiplication, a greater mask value may be assigned to the pass region than to the blocking region. For example, a value of ‘1’ may be assigned to the pass region, and a value of ‘0’ may be assigned to the blocking region (for complete blocking). However, in some cases, a value greater than ‘0’ may be assigned to the blocking region (for partial blocking), and a value less than ‘1’ (for partial passing) or greater than ‘1’ may be assigned to the pass region.

As another example, the frequency bands (i.e., pass frequency bands) corresponding to a plurality of band masks may be designed to have the same width. Referring further to the example illustrated in FIG. 6, the frequency band width (or pass region width) of the first region 62 extracted by the first band mask may be designed to be the same as that of the second region 63 extracted by the second band mask. In this case, the pass regions of the two band masks may be formed to have a diagonal shape, but the scope of the present disclosure is not limited thereto.

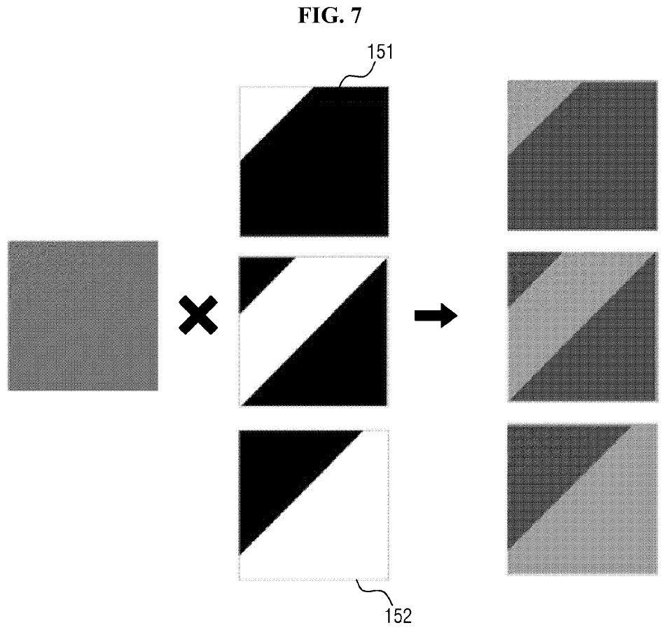

As another example, the frequency bands (i.e., pass frequency bands) corresponding to a plurality of band masks may be designed so that at least some of the plurality of band masks have different widths. For example, to comprehensively observe data across multiple frequency bands, a first band mask may be configured to pass a relatively wide frequency band, and to closely observe data of a specific frequency band, a second band mask may be configured to pass a relatively narrow frequency band. Alternatively, a first band mask associated with a frequency region of high importance (i.e., high importance for authenticity determination) may be configured to pass a relatively wide frequency band, and a second band mask associated with a frequency region of lower importance may be configured to pass a relatively narrow frequency band. Referring to FIG. 7 for further explanation, in a case where a high-frequency region is of greater importance than a low-frequency region (e.g., signals are concentrated in the low-frequency region, but high-frequency signals are more important), a first band mask 151 associated with the low-frequency region may be configured to pass a relatively narrow frequency band, and a second band mask 152 associated with the high-frequency region may be configured to pass a relatively wide frequency band. In this manner, authenticity determination may be performed with greater weight assigned to an important frequency region.

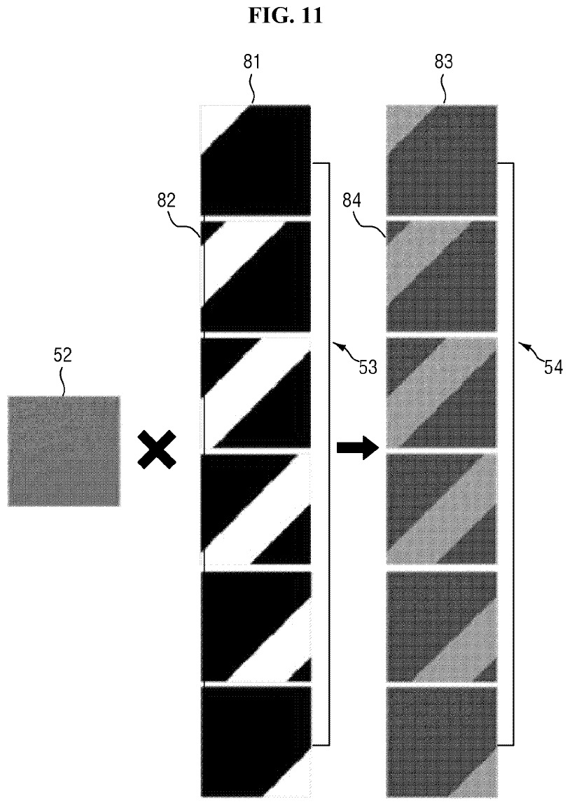

As another example, the shape or orientation (angle) of the pass regions of the plurality of band masks may be designed to be the same. For example, the pass regions of first and second band masks may be designed to be parallel to each other (see FIG. 11).

As another example, at least some of the pass regions of the plurality of band masks may be designed to have different shapes or orientations (angles).

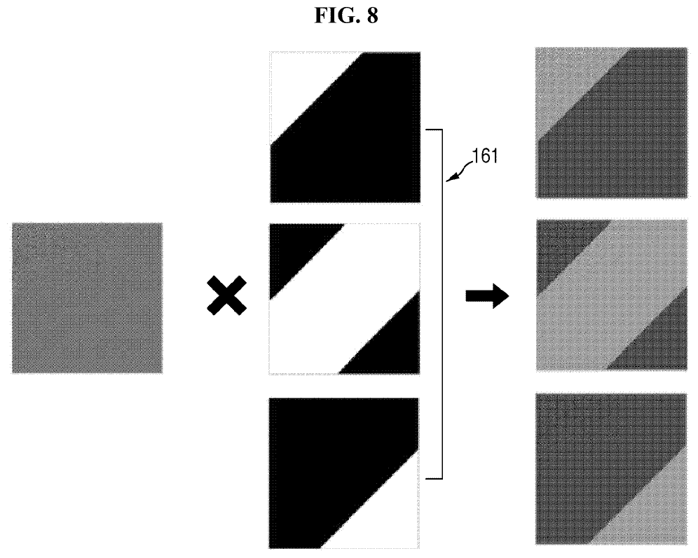

As another example, the number of band masks may be determined based on the frequency characteristics of an input image. Specifically, if the dispersion (or distribution) of frequencies (i.e., frequency signals) appearing in the input image is large (e.g., if a variety of frequencies appear), the number of band masks may be increased, and in the opposite case, the number of band masks may be reduced. Referring to FIG. 8 for further explanation, if signals are concentrated in a low-frequency region (i.e., there are only a few high-frequency signals and thus the frequency dispersion is small), and if the low-frequency region is also an important frequency region, then the number of band masks 161 may be reduced compared to the opposite case (e.g., while six band masks may be used when the frequency dispersion is large, only three band masks 161 are used in the example illustrated in FIG. 8). In this example, the number of band masks may be determined as a fixed value based on prior analysis of the frequency characteristics of each input image or may be dynamically adjusted according to the frequency characteristics of each input image.

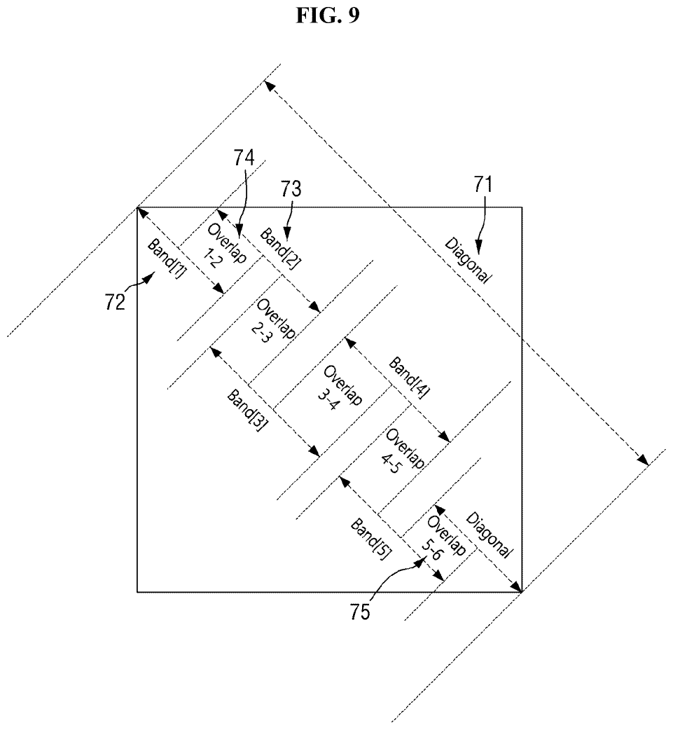

As another example, the frequency bands (i.e., pass frequency bands) corresponding to a plurality of band masks may be designed to have overlapping band regions. In this manner, loss of information (e.g., characteristic information of an image) included in a specific frequency band (e.g., between two frequency bands) may be prevented. This example will be further explained with reference to FIG. 9. FIG. 9 illustrates a case where the number of band masks is six.

As illustrated in FIG. 9, in order to prevent information loss during the process of extracting image data by frequency band, band masks may be designed so that an overlapping band region (e.g., 74 or 75) are formed between adjacent frequency bands (e.g., 72 and 73). FIG. 9 illustrates an example in which overlapping band regions are formed between all adjacent frequency bands (e.g., 72 and 73), but the scope of the present disclosure is not limited thereto. For example, if information in a high-frequency (or low-frequency) region is not important for image authenticity determination, an overlapping band region may be formed only in the low-frequency (or high-frequency) region.

Meanwhile, the widths of overlapping band regions (e.g., 74 or 75) may be designed to be the same or at least some of the overlapping band regions may be designed to have different widths.

For example, if the length of the diagonal 71 is D and the number of band masks is N, the basic width B of each frequency band 72 corresponding to the band masks may be determined as D/N, and the width V of the overlapping band region 74 may be determined as D/(N*(N−1)). Then, the frequency band width of each band mask considering the overlapping band region may be B+V or B. According to this example, band masks having overlapping band regions of equal width can be easily designed.

As another example, the width of an overlapping band region 74 located in the low-frequency (or high-frequency) region may be designed to be wider than that of an overlapping band region 75 located in the high-frequency (or low-frequency) region.

As another example, the width of overlapping band regions (e.g., 74 and 75) may be designed to gradually increase or decrease closer to the high-frequency region.

As another example, the width of an overlapping band region (e.g., 74) located in a specific frequency region may be designed to be greater than that of other overlapping band regions (e.g., 75). For example, if prior knowledge is given that information in the specific frequency region is important for image authenticity determination, the overlapping band region located in that frequency region may be configured to be wider.

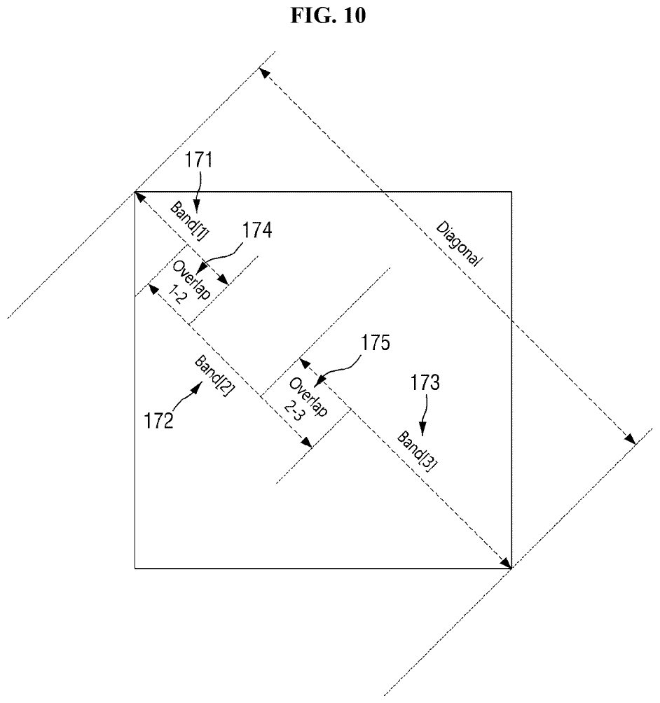

As another example, a plurality of band masks may be designed based on various combinations of the examples described above. For a specific example, as illustrated in FIG. 10, frequency bands 171 through 173 corresponding to the respective band masks may be designed to have different widths, and overlapping band regions 174 and 175 may also be designed to have different widths. For example, if the length of a diagonal is D and the number of band masks is N, the sum of the basic widths of the frequency bands corresponding to the band masks may be D (i.e., the values of B1 through BN may be determined such that B1+B2+ . . . +BN=D), and a width Vk of the overlapping band region 174 (where k is a natural number from 1 to less than N and Vk refers to the width of the overlapping band region between k-th and (k+1)-th frequency bands) may be determined as MIN(Bk, Bk+1)/4, but the scope of the present disclosure is not limited thereto.

Once band masks are designed and configured as described above, as illustrated in FIG. 11, the determination system 10 may apply a plurality of band masks 53 to a frequency-domain image 52, thereby extracting a plurality of image data 54 associated with different frequency bands. Specifically, the determination system 10 may extract first image data 83 associated with a first frequency band by applying a first band mask 81 to the frequency-domain image 52, and may extract second image data 84 associated with a second frequency band by applying a second band mask 82 to the frequency-domain image 52. By repeating this process for other band masks, the determination system 10 may extract data of the frequency-domain image 52 by frequency band.

For reference, an image in the spatial domain is converted to the frequency domain, and data is extracted by frequency band because the characteristics of the image captured by each frequency band differ, as shown in Table 1 below.

TABLE 1

| Band Classification | Characteristics |
|---|---|
| Low Frequency | Bold lines, large changes |
| High Frequency | Thin lines, fine changes |

Additionally, one of the reasons is that moiré phenomena on monitors can be more clearly identified in the frequency domain, and that subtle differences appear in each frequency band in the frequency domain between an image of an ID card and a captured image of a printed version of the ID card (e.g., due to material differences between plastic and paper, differences depending on printer type, paper type, paper thickness, etc., and distinct differences that appear in the hologram-coated area of the ID card). Therefore, image authenticity determination can be more accurately performed.

Meanwhile, in some embodiments, the determination system 10 may reflect values of learnable parameters in the process of extracting image data for a specific frequency band. Referring again to FIG. 11 for further explanation, the determination system 10 may extract the image data 83 associated with the first frequency band (or another frequency band) from the frequency-domain image 52 using the first band mask 81, and may reflect (e.g., via addition) values of learnable parameters (e.g., a weight matrix having the same size as the image data 83) in the image data 83, thereby generating final image data associated with the first frequency band (or another frequency band). At this time, the values of the learnable parameters may have been updated based on the differences between the authenticity prediction values and correct labels for the training image samples (i.e., the learnable parameters may be considered as components of the deep learning model). According to the present embodiments, image data for each frequency band may be modified to be more suitable for authenticity determination through the learnable parameters, and as a result, the accuracy of image authenticity determination may be further improved.

The description will now return to FIG. 4.

In step S43, image data may be inverse-transformed into the spatial domain, thereby generating a plurality of images. For example, as illustrated in FIG. 5, the determination system 10 may inverse-transform the image data 54 into images 55 in the spatial domain through an inverse transformation technique such as Inverse Discrete Cosine Transform (IDCT) or Inverse Discrete Fourier Transform (IDFT).

Although not clearly illustrated in FIG. 5, the module that performs the above-described inverse transformation may be referred to as an “inverse transformer,” and the inverse transformer may or may not be considered a component of the deep learning model.

In step S44, features may be extracted from the plurality of images. For example, as illustrated in FIG. 5, the determination system 10 may input the images 55 into a feature extractor 56 and extract features (e.g., feature maps) used for authenticity determination. The feature extractor 56 may, for example, be implemented based on a convolutional neural network (CNN), but the scope of the present disclosure is not limited thereto.

In step S45, the authenticity of a target image may be determined based on the extracted features. For example, as illustrated in FIG. 5, the determination system 10 may input the extracted features into a predictor 57 and obtain prediction values (e.g., confidence scores for a genuine class and a fake class) for the authenticity of the target image 51. Then, the determination system 10 may determine the target image 51 to be a genuine image based on a determination that the prediction values are greater than or equal to a threshold. In the opposite case, the determination system 10 may determine the target image 51 to be a fake image.

Up to this point, the image determination method according to some embodiments of the present disclosure has been described with reference to FIGS. 4 through 11. As described above, image data may be separated and extracted by frequency band through a plurality of band masks, and the authenticity of the image may be determined by comprehensively considering features extracted from the image data. Accordingly, the accuracy of authenticity determination for the image may be significantly improved. Additionally, by configuring the plurality of band masks to have overlapping band regions, multiple image data associated with different frequency bands may be extracted without information loss. As a result, the accuracy of authenticity determination for the image may be further improved.

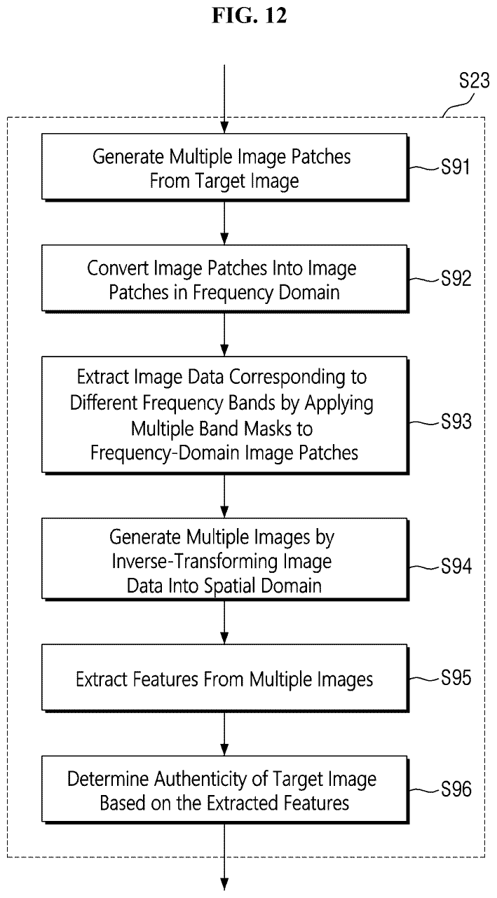

An image determination method according to other embodiments of the present disclosure will hereinafter be described with reference to FIGS. 12 through 14. However, for clarity of the present disclosure, descriptions of content overlapping with the previous embodiments will be omitted, and the technical ideas of the previous embodiments may be applied to the present embodiments even without separate description.

FIG. 12 is an exemplary flowchart illustrating an image determination method according to other embodiments of the present disclosure. However, it is noted that this is merely a preferred embodiment for achieving the objectives of the present disclosure, and some steps may be added or omitted as necessary. FIG. 12 illustrates only the authenticity determination process for a target image.

As illustrated in FIG. 12, the present embodiments relate to a method for performing authenticity determination by focusing more on characteristics that appear in frequency bands of local regions of an image. That is, the present embodiments may be understood as differing from the previous embodiments that perform authenticity determination using characteristics that appear in frequency bands of the entire (global) region of an image.

The reason for focusing on local regions of an image is that most compressed images (e.g., JPEG images) are generated through a block-based compression process (e.g., DCT transformation using 8×8 blocks). Specifically, images are generally stored in compressed file formats due to issues such as file size. Since image compression standards such as JPEG employ lossy compression techniques, data loss occurs in units of blocks during the compression process (e.g., during the stages of DCT transformation and quantization). In this case, a second-shot image, which is a type of fake image, undergoes two compression stages and exhibits different characteristics from the first-shot image, and such characteristics may appear differently on a per-block basis. Therefore, it may be understood that authenticity determination is performed by focusing more on the characteristics appearing in local regions of an image. The present embodiments will hereinafter be described in detail with reference to FIG. 12.

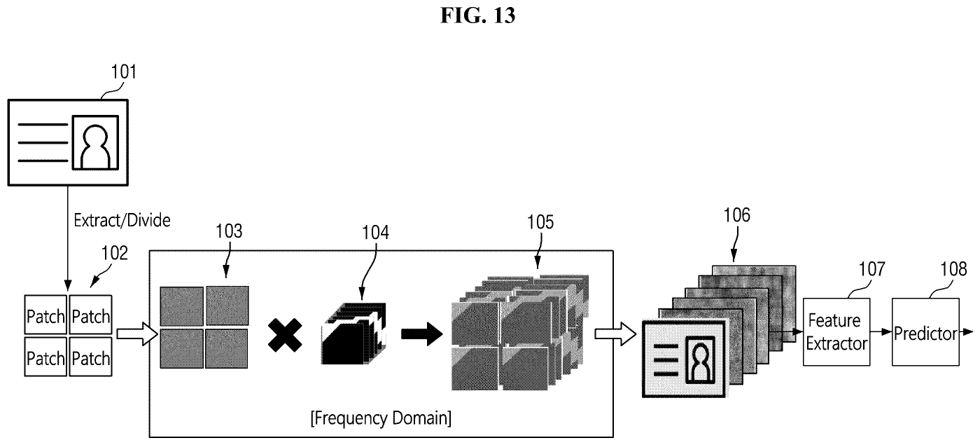

In step S91, a plurality of image patches may be generated from a target image. For example, as illustrated in FIG. 13, the determination system 10 may divide a target image 101 into a preset number of image patches 102, or may extract a preset number of image patches 102 from the target image. In this case, at least some of the extracted image patches 102 may or may not have overlapping regions.

In some embodiments, the size of each image patch may be set to be equal to the block size of the image compression technique or to be a multiple of the block size of the image compression technique (e.g., the unit block size of JPEG compression). For example, assuming that the target image is an RGB image obtained by decoding a JPEG image, the determination system 10 may divide the target image such that the image patch size is 8×8 or a multiple thereof (e.g., 16×16). In this manner, loss patterns from the compression process may be detected more accurately.

In step S92, the image patches may be transformed into image patches in the frequency domain. For example, as illustrated in FIG. 13, the determination system 10 may transform each of the image patches 102 into frequency-domain image patches 103. The explanation of step S41 may be further referenced for this step.

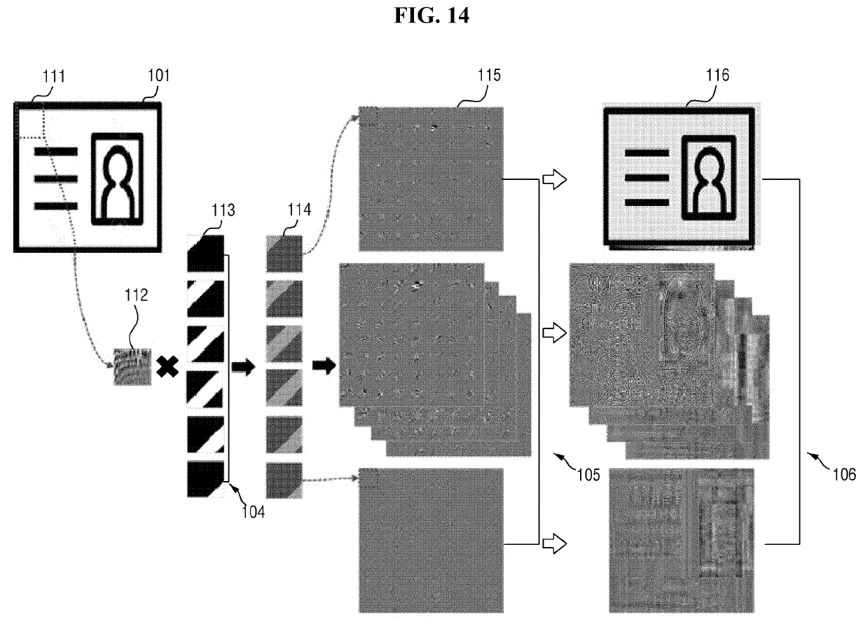

In steps S93 and S94, a plurality of band masks may be applied to the frequency-domain image patches to extract multiple image data associated with different frequency bands, and the extracted image data may be inverse-transformed into the spatial domain, thereby generating a plurality of images. For example, as illustrated in FIG. 13, the determination system 10 may apply a plurality of band masks 104 to the image patches 103 to extract multiple image data 105 associated with different frequency bands. Then, the determination system 10 may inverse-transform the image data 105 and may thereby generate a plurality of images 106. For an easier understanding, a further explanation will be provided with reference to FIG. 14.

As illustrated in FIG. 14, the determination system 10 may transform an image patch 111 of the target image 101, thereby acquiring a frequency-domain image patch 112. Thereafter, the determination system 10 may apply a plurality of band masks 113 to the image patch 112 and extract multiple patch data (e.g., 114) associated with different frequency bands. For example, the determination system 10 may apply a specific band mask 113 to the image patch 112 and extract patch data 114 associated with a specific frequency band, and may similarly extract patch data associated with other frequency bands. The determination system 10 may also perform the above-described process in the same manner for other image patches of the target image 101.

Thereafter, the determination system 10 may aggregate patch data by frequency band, thereby generating image data 105. For example, the determination system 10 may aggregate the patch data (e.g., 114) associated with the specific frequency band, thereby generating image data (e.g., 115) associated with the specific frequency band, and may similarly generate image data associated with other frequency bands.

Thereafter, the determination system 10 may inverse-transform the image data 105 by frequency band, thereby generating a plurality of images 106. For example, the determination system 10 may inverse-transform the image data (e.g., 115) associated with the specific frequency band into the spatial domain to generate an image (e.g., 116) associated with the specific frequency band, and may similarly generate images associated with other frequency bands.

For steps S93 and S94, the explanation of steps S42 and S43 may also be referenced.

A description will now be given again with reference to FIG. 12.

In step S95, features may be extracted from the plurality of images. For example, as illustrated in FIG. 13, the determination system 10 may input a plurality of images 106 into the feature extractor 107, thereby extracting features. For this step, the description of step S44 may be further referenced, and for the feature extractor 107, the description of the feature extractor 56 illustrated in FIG. 5 may be further referenced.

In step S96, the authenticity of the target image may be determined based on the extracted features. For example, as illustrated in FIG. 13, the determination system 10 may input the features extracted through the feature extractor 107 into the predictor 108, thereby determining the authenticity of the target image 101. For this step, the description of step S45 may be further referenced, and for the feature predictor 108, the description of the predictor 57 illustrated in FIG. 5 may be further referenced.

Up to this point, the image determination method according to other embodiments of the present disclosure has been described with reference to FIGS. 12 through 14. According to the foregoing, by performing frequency domain transformation and inverse transformation on a per-image patch basis, features per frequency band for a local region of the image may be extracted. In this case, since block-based loss patterns that appear in a compressed image such as JPEG can be more accurately detected, the authenticity determination accuracy for the image can be further improved.

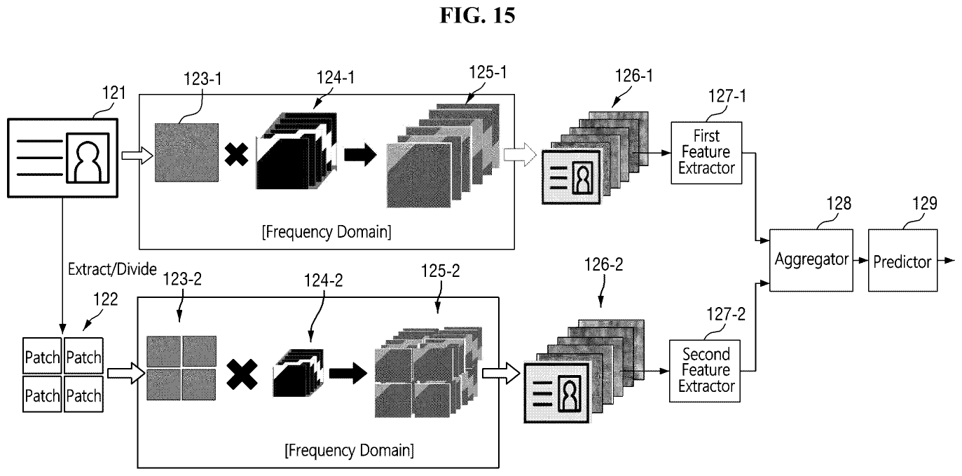

An image determination method according to yet other embodiments of the present disclosure will hereinafter be described with reference to FIG. 15. However, for clarity of the present disclosure, redundant descriptions overlapping with the previous embodiments will be omitted, and the technical ideas of the previous embodiments may be applied to the present embodiments even without separate statements.

FIG. 15 is an exemplary view for explaining an image determination method according to yet other embodiments of the present disclosure.

As illustrated in FIG. 15, the present embodiments relate to a method for more accurately determining the authenticity of a target image 121 based on a combination of the previous embodiments.

Specifically, the determination system 10 may transform the target image 121 into the frequency domain (see 123-1), extract image data using a plurality of band masks 124-1 (hereinafter referred to as “first band masks”) (see 125-1), and inverse-transform the extracted image data into the spatial domain, thereby generating a plurality of images 126-1 (hereinafter referred to as “first images”). Then, the determination system 10 may extract first features from the first images 126-1 through a first feature extractor 127-1. For this, the descriptions of FIGS. 4 and 5 may be further referenced.

Thereafter, the determination system 10 may transform a plurality of image patches 122 generated from the target image 121 into the frequency domain (see 123-2), extract image data using a plurality of band masks 124-2 (hereinafter referred to as “second band masks”) (see 125-2), and inverse-transform the extracted image data into the spatial domain, thereby generating a plurality of images 126-2 (hereinafter referred to as “second images”). Then, the determination system 10 may extract second features from the second images 126-2 through a second feature extractor 127-2. For this, the descriptions of FIGS. 12 and 13 may be further referenced.

Here, the first and second feature extractors 127-1 and 127-2 may refer to the same feature extractor or different feature extractors. Also, the first and second feature extractors 127-1 and 127-2 may be configured to share at least some parameters (i.e., learnable parameters).

Meanwhile, FIG. 15 illustrates an example where the number and some characteristics (e.g., shape, direction, pass region width, overlapping band region quantity and width, etc.) of the first band masks 124-1 are the same as or similar to those of the second band masks 124-2, but the scope of the present disclosure is not limited thereto. Alternatively, the number and characteristics of the first band masks 124-1 may be designed to be partially different from those of the second band masks 124-2. For example, depending on the frequency characteristics of the input image and patches (e.g., variance of frequencies), or the importance of frequency regions, the numbers, pass region widths (i.e., pass frequency band), and overlapping band region quantities and widths of the first band masks 124-1 and the second band masks 124-2 may be designed to differ.

Thereafter, the determination system 10 may aggregate the first features and the second features through an aggregator 128. The aggregator 128 may be implemented as a module that performs a predetermined aggregation operation (e.g., concatenation, element-wise multiplication, addition, stacking, etc.), or may be implemented as a module having learnable parameters, such as a neural network layer (e.g., fully connected layer or MLP). The aggregator 128 may be implemented in any form. In some embodiments, the aggregator 128 may further include a layer that performs a pooling operation (e.g., average pooling, etc.).

Thereafter, the determination system 10 may input the aggregated features into a predictor 129, thereby determining the authenticity of the target image 121. In this case, the authenticity determination accuracy for the target image 121 can be further improved, for reasons similar to those described above. Specifically, when loss compression (e.g., JPEG compression) is performed on an image on a per-block basis, data loss occurs on a per-block basis, causing differences between features extracted from the global region and the local region of the image. Furthermore, a second-shot image, which is a type of forged image, undergoes two rounds of data loss, making such differences more pronounced. As a result, more accurate authenticity determination for the image is enabled.

Meanwhile, in some embodiments, the determination system 10 may further extract third features from the target image 121 or the image patches 122. Then, the determination system 10 may aggregate the first features, the second features, and the third features through the aggregator 128 and determine the authenticity of the target image 121 based on the aggregated features. In this case, by additionally considering features extracted in the spatial domain, the authenticity determination accuracy for the target image 121 can be further improved.

Up to this point, an image determination method according to yet other embodiments of the present disclosure has been described with reference to FIG. 15. According to the foregoing, by collectively considering the first features for the global region and the second features for the local region of the image, the authenticity determination accuracy for the image can be further improved.

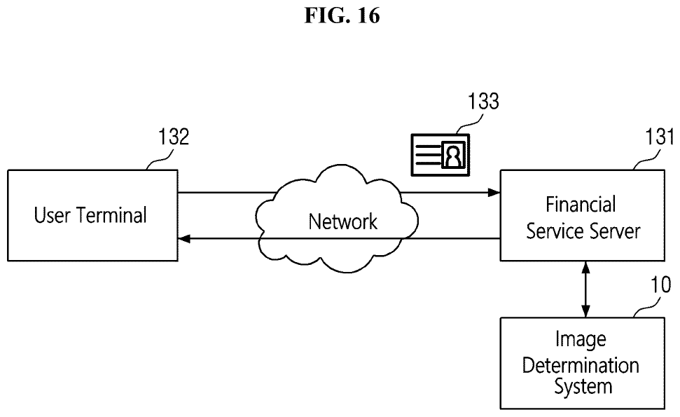

An application example of the determination system 10 described above will hereinafter be briefly introduced with reference to FIG. 16.

As illustrated in FIG. 16, the determination system 10 may be utilized to enhance a non-face-to-face authentication function in a financial service. The determination system 10 may also be utilized in other types of services where image authenticity determination is required.

Specifically, it is assumed that a user requests a financial service such as opening a new account and performs non-face-to-face authentication. Also, it is assumed that the user transmits an ID image 133 to a financial service server 131 through a terminal 132. In this case, the financial service server 131 may perform user authentication (i.e., identity verification) based on the ID image 133 in cooperation with the determination system 10.

More specifically, the financial service server 131 may send a request to the determination system 10 to determine the authenticity of the ID image 133, and the determination system 10 may respond to the request by performing authenticity determination for the ID image 133 and providing the authenticity determination result to the financial service server 131.

Then, the financial service server 131 may proceed with user authentication based on the authenticity determination result. For example, if the ID image 133 is determined to be a forged image, the financial service server 131 may determine that authentication has failed and reject the user's request for the financial service. If the ID image 133 is determined to be a genuine image, the financial service server 131 may authenticate the user based on the information included in the ID image 133, and if the authentication is successfully completed, provide the requested financial service to the user.

For reference, the network illustrated in FIG. 16 may be implemented using any type of wired/wireless network, such as a Local Area Network (LAN), a Wide Area Network (WAN), a mobile radio communication network, or Wireless Broadband Internet (WiBro).

Up to this point, an application example of the determination system 10 described above has been described with reference to FIG. 16. According to the foregoing, by performing authenticity determination for an ID image, vulnerabilities of a non-face-to-face authentication function can be addressed, and the security of the non-face-to-face financial service can be significantly enhanced.

An exemplary computing device 140 capable of implementing the determination system 10 according to some embodiments of the present disclosure will hereinafter be described with reference to FIG. 17.

FIG. 17 is an exemplary hardware configuration diagram illustrating the computing device 140.

As illustrated in FIG. 17, the computing device 140 may include at least one processor 141, a bus 143, a communication interface 144, a memory 142 that loads a computer program 146 executed by the processor 141, and a storage 145 that stores the computer program 146. However, only components relevant to the embodiments of the present invention are illustrated in FIG. 17. Therefore, those skilled in the art will understand that additional general-purpose components may also be included beyond the components illustrated in FIG. 17.

The processor 141 controls the overall operation of the components of the computing device 140. The processor 141 may include at least one of a central processing unit (CPU), a micro processor unit (MPU), a micro controller unit (MCU), a graphics processing unit (GPU), or any other type of processor well known in the technical field of the present invention. Additionally, the processor 141 may perform computations for at least one application or program to execute the methods/operations according to various embodiments of the present invention. The computing device 140 may be equipped with one or more processors.

The memory 142 stores various data, commands, and/or information. To execute the methods/operations according to various embodiments of the present invention, the memory 142 may load one or more programs 146 from the storage 145. For example, when the computer program 146 is loaded into the memory 142, logic (or modules) may be implemented on the memory 142. An example of the memory 142 may be, but is not limited to a RAM.

The bus 143 provides communication functions between the components of the computing device 140. The bus 143 may be implemented in various forms such as an address bus, data bus, and control bus.

The communication interface 144 supports wired and wireless internet communication for the computing device 140. The communication interface 144 may also support various communication methods other than internet communication. For this purpose, the communication interface 144 may include a communication module well known in the technical field of the present invention.

The storage 145 may non-transiently store one or more computer programs 146. The storage 145 may include a non-volatile memory such as a flash memory, hard disks, removable disk, or any other type of computer-readable recording medium well known in the technical field of the present invention.

The computer program 146 may include one or more instructions implementing the methods/operations according to various embodiments of the present invention. When the computer program 146 is loaded into the memory 142, the processor 141 may execute the instructions to perform the methods/operations according to various embodiments of the present invention.

For example, the computer program 146 may include one or more instructions for performing the operations of: converting a target image in the spatial domain into an image in the frequency domain; extracting first image data associated with a first frequency band by applying a first band mask to the frequency-domain image; extracting second image data associated with a second frequency band by applying a second band mask to the frequency-domain image; generating a plurality of images by inverse-transforming the first image data and the second image data into the spatial domain; and determining the authenticity of the target image based on features extracted from the plurality of images. In this case, the determination system 10 according to some embodiments of the present disclosure may be implemented through the computing device 140.

Meanwhile, in some embodiments, the computing device 140 illustrated in FIG. 17 may refer to a virtual machine implemented based on cloud technology. For example, the computing device 140 may be a virtual machine operating on one or more physical servers included in a server farm. In this case, at least some of the processor 141, the memory 142, and the storage 145 illustrated in FIG. 17 may be implemented as virtual hardware, and the communication interface 144 may also be implemented as a virtualized networking element such as a virtual switch.

Up to this point, an exemplary computing device 140 capable of implementing the determination system 10 according to some embodiments of the present disclosure has been described with reference to FIG. 17.

Thus far, various embodiments of the present invention and their effects have been described with reference to FIGS. 1 through 17. The effects according to the technical scope of the present invention are not limited to the effects mentioned above, and other effects not mentioned may be clearly understood by those skilled in the art from the description below.

The technical scope of the present invention described thus far may be implemented as computer-readable code on a computer-readable medium. The computer-readable recording medium may be, for example, a removable recording medium (CD, DVD, Blu-ray disc, USB storage device, removable hard disk) or a fixed recording medium (ROM, RAM, hard disk built into a computer). The computer program recorded on the computer-readable recording medium may be transmitted over a network such as the internet to other computing devices, installed on the other computing devices, and used on those devices.

While all components constituting the embodiments of the present invention have been described as being combined or operating in combination, the technical scope of the present invention is not necessarily limited to such embodiments. That is, within the scope of the present invention, all components may be selectively combined and operate in various configurations.

Although operations are illustrated in the drawings in a specific sequence, it should not be understood that the operations must be performed in the illustrated order, sequentially, or that all operations must be performed to achieve desired results. In certain circumstances, multitasking and parallel processing may be advantageous. Furthermore, the separation of various configurations described in the embodiments above should not be understood as mandatory, and it should be understood that the described program components and systems may generally be integrated into a single software product or packaged as multiple software products.

Although the embodiments of the present invention have been described with reference to the attached drawings, those skilled in the art will understand that the present invention may be embodied in other specific forms without changing its technical scope or essential characteristics. Therefore, the embodiments described above should be understood as illustrative rather than limiting in every respect. The scope of protection of the present invention should be interpreted according to the appended claims, and all technical concepts within equivalent scope should be interpreted as being included in the technical scope defined by the present invention.

What is claimed is:

1. An image determination method performed by at least one computing device, comprising:
converting a target image in a spatial domain into an image in a frequency domain;
extracting first image data associated with a first frequency band by applying a first band mask to the frequency-domain image;
extracting second image data associated with a second frequency band by applying a second band mask to the frequency-domain image, wherein the first and second frequency bands have an overlapping band region;
generating a plurality of images by inverse-transforming the first image data and the second image data into the spatial domain; and
determining authenticity of the target image based on features extracted from the plurality of images.

2. The image determination method of claim 1, wherein the target image is an image related to a subject on which personal information is recorded.

3. The image determination method of claim 2, wherein the subject includes at least one of an ID card and a card.

4. The image determination method of claim 2, wherein
the target image is obtained during a process of authenticating a user who has requested a financial service, and
an authentication result for the user is determined based on a result of the determining of the authenticity of the target image.

5. The image determination method of claim 1, wherein the plurality of images include an image associated with the first frequency band and an image associated with the second frequency band.

6. The image determination method of claim 1, wherein the first band mask is configured to extract data of a region formed in a diagonal direction in the frequency-domain image.

7. The image determination method of claim 1, wherein
the extracting of the first image data comprises: extracting image data located in a region of the first frequency band in the frequency-domain image through the first band mask; and generating the first image data by reflecting values of learnable parameters on the extracted image data, and
the values of the learnable parameters are updated based on differences between authenticity prediction values and correct labels for training image samples.

8. The image determination method of claim 1, wherein
the band region is a first band region,
the generating of the plurality of images comprises: extracting third image data associated with a third frequency band by applying a third band mask to the frequency-domain image; and generating the plurality of images by further inverse-transforming the third image data,
the third frequency band has a second band region that overlaps the second frequency band or another frequency band, and
a width of the first band region is equal to a width of the second band region.

9. The image determination method of claim 1, wherein
the plurality of images are first images,
the extracted features are first features, and
the determining of the authenticity of the target image comprises: generating a plurality of image patches from the target image; converting the plurality of image patches into the frequency domain; extracting multiple image data of different frequency bands through a plurality of band masks; generating second images by inverse-transforming the multiple image data of the different frequency bands into the spatial domain; and determining the authenticity of the target image based further on second features extracted from the second images.

10. The image determination method of claim 1, wherein the determining of the authenticity of the target image comprises: extracting the features through a convolutional neural network (CNN)-based feature extractor; and determining the authenticity of the target image through a fully-connected-layer-based predictor.

11. The image determination method of claim 1, wherein the determining of the authenticity of the target image comprises determining whether the target image is a first-shot image obtained by capturing a physical subject or a second-shot image obtained by re-capturing the first-shot image.

12. The image determination method of claim 1, wherein the determining of the authenticity of the target image comprises determining whether the target image is an image obtained by capturing a three-dimensional subject or an image obtained by capturing a two-dimensional subject.

13. An image determination method performed by at least one computing device, comprising:
generating a plurality of image patches from a target image in a spatial domain;
converting the plurality of image patches into image patches in a frequency domain;
extracting first image data associated with a first frequency band by applying a first band mask to the frequency-domain image patches;
extracting second image data associated with a second frequency band by applying a second band mask to the frequency-domain image patches, wherein the first frequency band and the second frequency band have an overlapping band region;
generating a plurality of images by inverse-transforming the first image data and the second image data into the spatial domain; and
determining the authenticity of the target image based on features extracted from the plurality of images.

14. The image determination method of claim 13, wherein
the target image is obtained by decoding an image compressed through a block-based image compression scheme, and
a size of each of the image patches is set to a block size of the image compression scheme or a multiple of the block size.

15. The image determination method of claim 13, wherein the extracting of the first image data comprises: extracting a plurality of patch data associated with the first frequency band from the frequency-domain image patches through the first band mask; and generating the first image data by aggregating the plurality of patch data.

16. An image determination system comprising:
at least one processor; and
a memory storing instructions,
wherein the at least one processor is configured to perform, by executing the stored instructions, operations of: converting a target image in a spatial domain into an image in a frequency domain; extracting first image data associated with a first frequency band by applying a first band mask to the frequency-domain image; extracting second image data associated with a second frequency band by applying a second band mask to the frequency-domain image, wherein the first and second frequency bands have an overlapping band region; generating a plurality of images by inverse-transforming the first image data and the second image data into the spatial domain; and determining authenticity of the target image based on features extracted from the plurality of images.

17. The image determination system of claim 16, wherein the target image is an image related to a subject on which personal information is recorded.

18. The image determination system of claim 17, wherein the subject includes at least one of an ID card and a card.

19. The image determination system of claim 17, wherein
the target image is obtained during a process of authenticating a user who has requested a financial service, and
an authentication result for the user is determined based on a result of the determining of the authenticity of the target image.

20. The image determination system of claim 16, wherein the plurality of images include an image associated with the first frequency band and an image associated with the second frequency band.
